(19) United States
(12) Patent Application Publication
(10) Pub. No.: US 2026/0162003 A1
(43) Pub. Date: Jun. 11, 2026

(54) METHOD AND SYSTEM FOR GENERATING SYNTHETIC DATA FOR TRAINING MODELS

(71) Applicant: JPMorgan Chase Bank, N.A., New York, NY (US)

(72) Inventors: Jacob MAROLD, Pound Ridge, NY (US); Juan ZHA, Mission San Jose, CA (US); Mike DAI, East Rutherford, NJ (US); Kenil TANNA, New York, NY (US); Joel NYBECK, New York, NY (US)

(73) Assignee: JPMorgan Chase Bank, N.A., New York, NY (US)

(21) Appl. No.: 18/977,222

(22) Filed: Dec. 11, 2024

(51) Int. Cl. G06N 20/00; G06F 40/103; G06F 40/177; G06F 40/186

(52) U.S. Cl. CPC G06N 20/00; G06F 40/103; G06F 40/177; G06F 40/186

(57) ABSTRACT

A method and a system for generating synthetic data for training a domain-specific model are provided. The method includes: accessing a first dataset that includes attributes associated with a domain of the domain-specific model; accessing templates in a predetermined format that include at least one variable; selecting a first textual template from among the at least one textual template; generating a synthetic dataset by substituting each respective variable of the first textual template with a respective attribute from the first dataset such that each respective attribute is arranged in a sequence defined by the first textual template; and training, the domain-specific model using the synthetic dataset. Each respective text string provides a natural language simulated example, and each respective corresponding label sequence provides contextual information to facilitate learning by the domain-specific model.

### BACKGROUND

### 1. Field of the Disclosure

This disclosure generally relates to methods and systems for generating synthetic data for training a domain-specific model, and more particularly to methods and systems for generating two-dimensional synthetic training data that includes both a text string with example attributes and a label sequence for providing locality information of each attribute within the textual string, in order to enable rapid, accurate, and reliable training of a model.

### 2. Background Information

Machine learning model training and testing depend on an abundance of accurately labeled data. For natural language processing (NLP) tasks, labeled data include a set of (X, Y) pairs, where X represents the input string/text, and Y represents a set of objectives to be trained via an appropriate algorithm. Within NLP, complexity in labeling can be exacerbated by document length, language ambiguity, and domain expertise requirements. For example, it is not uncommon to have a collection of multipage documents or entire chat conversations which must meticulously be examined for correctness to arrive at a single training example. Named Entity Recognition (NER) and corresponding relation classification represent especially tedious labeling tasks. Substrings of text must be carefully selected to establish labels, and sequencing of numbered events/relations must be tracked through multipage documents or long chat histories.

Moreover, especially within financial contexts, there is a scarcity of pre-existing, publicly available labeled data to leverage for transfer learning. While some model deployment scenarios may permit rapid collection of labeled data through user feedback, others do not. For example, if the number of classification categories remains reasonable for human correction through action within a deployed system, and if the classification task is closely aligned with the deployment objective, it is possible to crowd-source feedback and valuable training data through normal user actions within the system with no/little additional effort. One example of this is email spam detection, whereby a simple button can inform on False Positives (a spam email is recognized as not spam) and False Negatives (a non-spam email is predicted as spam). Unfortunately, in a variety of tasks/domains (e.g., financial domains), the close alignment of deployment objectives is often disconnected from the classification task. One example of this is in algorithmic trade idea generation, where missed trades are classified within financial chats, yet the end state the user experiences is a recommendation on a potentially related product. This disconnection makes it trickier to collect labeled data easily from a feedback loop.

Within natural language processing machine learning applications, models must be continually updated. These updates are typically performed after sufficient manual annotation. Within financial contexts, some errors can be catastrophic to the user experience. For example, some confusions in the form entry of financial details for ticket booking would double the work required for users to fix, resulting in a net negative benefit of the application, and potentially lost revenue. In these situations, errors are expected to be remedied quickly. Due to the time-delay between user-experienced error and model retraining iterations, this is undesirable where user experienced errors can persist for weeks or months until a sufficient amount of labeled data has been collected to remedy the errors upon the next model retraining iteration. Moreover, the quantity of samples required to remedy errors within NLP model systems is not well understood. Due to the variety of textual features and encoding strategy, many correct examples of common language patterns may need to be introduced before a desired model behavior on output is achieved. As NLP technologies have been introduced into financial trading workflows, the aforementioned problems become of the utmost importance. One typical scenario is whereby client inquiries for requests for quotes are received and must be translated to ticket information via automated systems. Typically, a client will send requests which contain the necessary information needed for a trade, and the salesperson is responsible for processing those requests into a completed leg that is ready to trade. Within fixed-income trading, this might include capturing important product mentions (e.g., tickers, coupon, issuers, maturities, issuer, person, amount, etc.) from text snippets, followed-by normalizations of specific values (e.g., volumetric amounts, dates, etc.), and synthesis of information (e.g., identifying specific trade-legs, which may have shared attributes—e.g., buying applies to all request for quotes (RFQs) in a subsequent table).

For example, a salesperson may say the below text snippet sent by client though a digital chat room: “JOHN DOE \n 09:51:18 Can I see ukt 2035/2051 in 35 k$ pls”, what the salesperson will see is that the client “JOHN DOE” is showing the intention to buy the ticker “ukt” with maturity “2035” or “2051” with an amount of “35 k” in currency “$”. The key entity information will need to be organized into a leg to finally enable the trade booking of fixed income products through some booking engine. Extracting and organizing the leg trade from the raw input is time-consuming and error prone. Training one/two natural language understanding models is an ideal way to expedite this process, which helps increase efficiency in daily business.

Particularly, current natural language processing (NLP) synthetic data generating systems and methods may only produce one-dimensional training data, which lacks annotations that provide model learnable categories with regard to the synthetic data that is produced. This lack of labeled information does not permit machine learning systems to directly ingest in model training or testing processing. Furthermore, financial text often has a higher concentration of labeled information within text, rendering open-source methodologies or developments less useful in generating high quality data to be used for financial applications. Accordingly, there is a need for the generation of robust training data for a desired system behavior. Particularly, a method and system are needed for generating two-dimensional synthetic training data that includes both a text string with example attributes and a label sequence for providing locality information of each attribute within the textual string, in order to enable rapid, accurate, and reliable training of a model.

### SUMMARY

The present disclosure, through one or more of its various aspects, embodiments, and/or specific features or sub-components, provides, inter alia, various systems, servers, devices, methods, media, programs, and platforms for generating two-dimensional synthetic training data that includes both a text string with example attributes and a label sequence for providing locality information of each attribute within the textual string, in order to enable rapid, accurate, and reliable training of a model, in order to enable rapid, accurate, and reliable training of a model.

According to an aspect of the present disclosure, a method for generating synthetic data for training a domain-specific model is provided. The method may be implemented by at least one processor. The method may include: accessing, by the at least one processor, a first dataset that includes a plurality of attributes associated with a domain of the domain-specific model; accessing, by the at least one processor, at least one textual template in a predetermined format, wherein each of the at least one textual template includes at least one variable; selecting, by the at least one processor, a first textual template from among the at least one textual template; generating, by the at least one processor, a synthetic dataset by substituting each respective at least one variable of the first textual template with a respective attribute from the first dataset such that each respective attribute is arranged in a sequence defined by the first textual template, wherein the synthetic data set includes at least one pairing of a respective text string with a respective label sequence, wherein each respective text string is separated into a plurality of respective substrings, and wherein each respective label sequence includes a respective label that corresponds with each respective substring of the plurality of respective substrings; and training, by the at least one processor, the domain-specific model using the synthetic dataset, wherein each respective text string provides a natural language simulated example, and each respective corresponding label sequence provides contextual information to facilitate learning by the domain-specific model.

The first dataset may be accessed via at least one from among a database, a generation function, and a large language model (LLM).

Each respective textual template of the at least one textual template may include a respective sequence of attributes associated with the domain-specific model, and wherein each respective variable of the at least one variable is an attribute label associated with a corresponding attribute from the respective sequence of attributes.

Each respective label sequence may include a corresponding starting position index and a corresponding ending position index for each category of interest in each respective corresponding text string.

Each respective label sequence may identify and correspond to a complete set of attributes within a synthetic example.

The synthetic dataset may include a simulated noise, wherein the simulated noise includes at least one from among language variation in words, a random capitalization, a random punctuation, and a random greeting word within at least one respective substring.

The domain-specific model may include a financial transaction labeling model.

The plurality of attributes may be associated with a financial language, and wherein the plurality of attributes includes at least one from among a ticker, a coupon, a maturity, an International Securities Identification Number (ISIN), an issuer, a Committee on Uniform Securities Identification Procedures (CUSIP) number, a price, a volume, an expiry date, a barrier option, a product identifier, a yield, a currency, a person, an organization series, and a spread.

The synthetic dataset may be formatted as a table that includes synthetic multi-leg trading data for at least one from among a buying of a respective financial product and a selling of a respective financial product.

According to another aspect of the present disclosure, a computing apparatus for generating synthetic data for training a domain-specific model is provided. The computing apparatus may include a processor; a memory; and a communication interface coupled to each of the processor, and the memory. The processor may be configured to: access a first dataset that includes a plurality of attributes associated with a domain of the domain-specific model; access at least one textual template in a predetermined format, wherein each of the at least one textual template includes at least one variable; select a first textual template from among the at least one textual template; generate a synthetic dataset by substituting each respective at least one variable of the first textual template with a respective attribute from the first dataset such that each respective attribute is arranged in a sequence defined by the first textual template, wherein the synthetic data set includes at least one pairing of a respective text string with a respective label sequence, wherein each respective text string is separated into a plurality of respective substrings, and wherein each respective label sequence includes a respective label that corresponds with each respective substring of the plurality of respective substrings; and train the domain-specific model using the synthetic dataset, wherein each respective text string provides a natural language simulated example, and each respective corresponding label sequence provides contextual information to facilitate learning by the domain-specific model.

The first dataset may be accessed via at least one from among a database, a generation function, and an LLM.

Each respective textual template of the at least one textual template may include a respective sequence of attributes associated with the domain-specific model, and wherein each respective variable of the at least one variable is an attribute label associated with a corresponding attribute from the respective sequence of attributes.

Each respective label sequence may include a corresponding starting position index and a corresponding ending position index for each respective category of interest in each corresponding text string.

Each respective label sequence may identify and correspond to a complete set of attributes within a synthetic example.

The synthetic dataset may include a simulated noise, wherein the simulated noise includes at least one from among language variation in words, a random capitalization, a random punctuation, and a random greeting word within at least one respective substring.

The domain-specific model may include a financial transaction labeling model.

The plurality of attributes may be associated with a financial language, and wherein the plurality of attributes includes at least one from among a ticker, a coupon, a maturity, an ISIN, an issuer, a CUSIP number, a price, a volume, an expiry date, a barrier option, a product identifier, a yield, a currency, a person, an organization series, and a spread.

The synthetic dataset may be formatted as a table that includes synthetic multi-leg trading data for at least one from among a buying of a respective financial product and a selling of a respective financial product.

According to yet another aspect of the present disclosure, a non-transitory computer readable storage medium storing instructions for streamlining data processing by transforming data is provided. The storage medium includes executable code which, when executed by a processor, may cause the processor to: access a first dataset that includes a plurality of attributes associated with a domain of the domain-specific model; access at least one textual template in a predetermined format, wherein each of the at least one textual template includes at least one variable; select a first textual template from among the at least one textual template; generate a synthetic dataset by substituting each respective at least one variable of the first textual template with a respective attribute from the first dataset such that each respective attribute is arranged in a sequence defined by the first textual template, wherein the synthetic data set includes at least one pairing of a respective text string with a respective label sequence, wherein each respective text string is separated into a plurality of respective substrings, and wherein each respective label sequence includes a respective label that corresponds with each respective substring of the plurality of respective substrings; and train the domain-specific model using the synthetic dataset, wherein each respective text string provides a natural language simulated example, and each respective corresponding label sequence provides contextual information to facilitate learning by the domain-specific model.

The first dataset may be accessed via at least one from among a database, a generation function, and an LLM.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for generating two-dimensional synthetic training data that includes both a text string with example attributes and a label sequence for providing locality information of each attribute within the textual string, in order to enable rapid, accurate, and reliable training of a model, according to an embodiment.

FIG. 2 illustrates a diagram of a network environment for generating two-dimensional synthetic training data that includes both a text string with example attributes and a label sequence for providing locality information of each attribute within the textual string, in order to enable rapid, accurate, and reliable training of a model, according to an embodiment.

FIG. 3 illustrates a system diagram of a system for generating two-dimensional synthetic training data that includes both a text string with example attributes and a label sequence for providing locality information of each attribute within the textual string, in order to enable rapid, accurate, and reliable training of a model, according to an embodiment.

FIG. 4 illustrates a process diagram of a process for generating two-dimensional synthetic training data that includes both a text string with example attributes and a label sequence for providing locality information of each attribute within the textual string, in order to enable rapid, accurate, and reliable training of a model, according to an embodiment.

FIG. 5 illustrates an architectural diagram of a process for generating two-dimensional synthetic training data that includes both a text string with example attributes and a label sequence for providing locality information of each attribute within the textual string, in order to enable rapid, accurate, and reliable training of a model, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein generates two-dimensional synthetic training data to enable rapid, accurate, and reliable training of a domain-specific model, according to an embodiment. The two-dimensional synthetic training data includes (x, y) pairs of data, such that it includes both textual strings (i.e., x) and corresponding label sequences (i.e., y). Particularly, the system accesses a dataset of attributes that are common to or associated with the domain-specific model. The system also accesses textual templates that represent common structures or sequences of text that will be analyzed and processed by the domain-specific model. The system may generate the textual template. The system then uses one of the templates to generate a synthetic dataset of textual strings by plugging in a variety of attributes from the dataset of attributes into the template. Each attribute belongs to a certain category, and the location within the generated textual string that each attribute is plugged into, is based on their respective category label, according to the sequence labels specified by the template. The synthetic dataset includes both the generated textual strings, as well the respective corresponding label sequence that identifies the corresponding categories of each respective attribute. Once the synthetic dataset is created, the system uses the synthetic dataset to train the domain-specific model using both the generated textual strings and the corresponding label sequence.

By generating two-dimensional synthetic training data, the system is able to reduce the time required for training models, while also improving the accuracy of the output data generated by the models. Particularly, the system provides additional contextual and sequencing information with regard to the synthetic data that is produced. This additional information reduces the time required for the training of the model and also results in more accurate and robust training of the model.

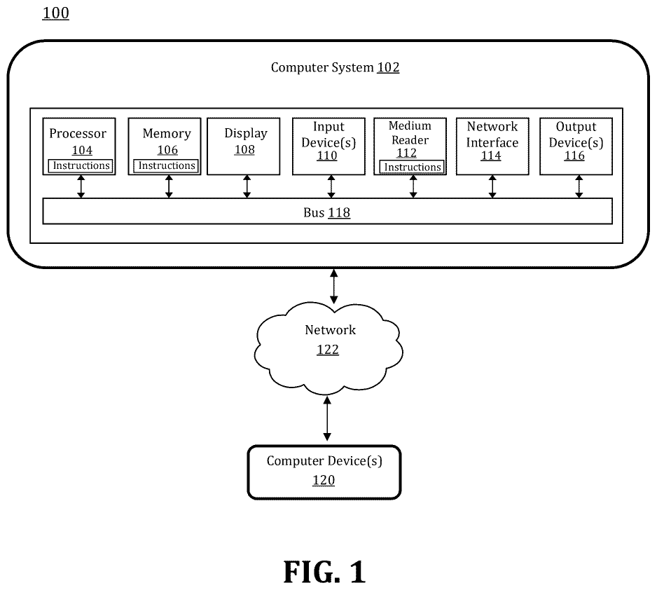

FIG. 1 is a system 100 for generating two-dimensional synthetic training data that includes both a text string with example attributes and a label sequence for providing locality information of each attribute within the textual string, in order to enable rapid, accurate, and reliable training of a model, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the synthetic data generating module implemented by the system 100 may allow for generating two-dimensional synthetic training data that includes both a text string with example attributes and a label sequence for providing locality information of each attribute within the textual string, in order to enable rapid, accurate, and reliable training of a model. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

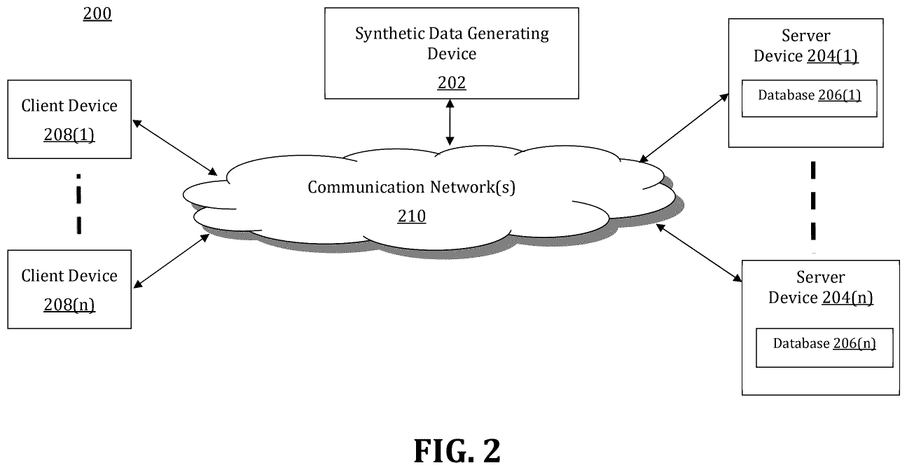

Referring to FIG. 2, a schematic of a network environment 200 for generating two-dimensional synthetic training data that includes both a text string with example attributes and a label sequence for providing locality information of each attribute within the textual string, in order to enable rapid, accurate, and reliable training of a model is illustrated.

In some embodiments, the above-described problems associated with conventional tools may be overcome by implementing a synthetic data generating device 202 as illustrated in FIG. 2 that may be configured for generating two-dimensional synthetic training data that includes both a text string with example attributes and a label sequence for providing locality information of each attribute within the textual string, in order to enable rapid, accurate, and reliable training of a model, but the disclosure is not limited thereto.

The synthetic data generating device 202 may include one or more computer systems 102, as described with respect to FIG. 1, which in aggregate provide the necessary functions.

The synthetic data generating device 202 may store one or more applications that can include executable instructions that, when executed by the synthetic data generating device 202, cause the synthetic data generating device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the synthetic data generating device 202 itself, may be located in virtual server(s) running in a cloud-based computing environment rather than being tied to one or more specific physical network computing devices. Also, the application(s) may be running in one or more virtual machines (VMs) executing on the synthetic data generating device 202. Additionally, in one or more embodiments of this technology, virtual machine(s) running on the synthetic data generating device 202 may be managed or supervised by a hypervisor.

In the network environment 200 of FIG. 2, the synthetic data generating device 202 may be coupled to a plurality of server devices 204(1)-204(n) that hosts a plurality of databases 206(1)-206(n), and also to a plurality of client devices 208(1)-208(n) via communication network(s) 210. A communication interface of the synthetic data generating device 202, such as the network interface 114 of the computer system 102 of FIG. 1, operatively couples and communicates between the synthetic data generating device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the synthetic data generating device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The synthetic data generating device 202 may be a standalone device or integrated with one or more other devices or apparatuses, such as one or more of the server devices 204(1)-204(n), for example. In one example, the synthetic data generating device 202 may be hosted by one of the server devices 204(1)-204(n), and other arrangements are also possible. Moreover, one or more of the devices of the synthetic data generating device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the synthetic data generating device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the synthetic data generating device 202 that may generate two-dimensional synthetic training data that includes both a text string with example attributes and a label sequence for providing locality information of each attribute within the textual string, in order to enable rapid, accurate, and reliable training of a model.

The client devices 208(1)-208(n) may run interface applications, such as standard web browsers or standalone client applications, which may provide an interface to communicate with the synthetic data generating device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the synthetic data generating device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the synthetic data generating device 202, the server devices 204(1)-204(n), or the client devices 208(1)-208(n), for example, may be configured to operate as virtual instances on the same physical machine. For example, one or more of the synthetic data generating devices 202, the server devices 204(1)-204(n), or the client devices 208(1)-208(n) may operate on the same physical device rather than as separate devices communicating through communication network(s) 210. Additionally, there may be more or fewer synthetic data generating devices 202, server devices 204(1)-204(n), or client devices 208(1)-208(n) than illustrated in FIG. 2. In some embodiments, the synthetic data generating device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

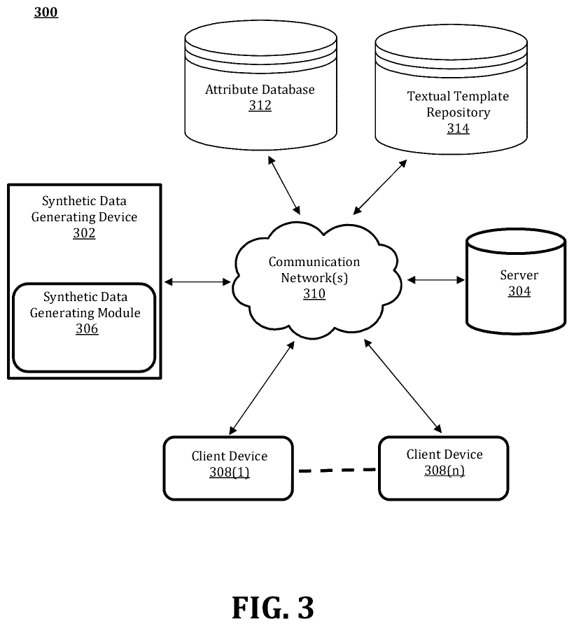

FIG. 3 illustrates a system diagram for generating two-dimensional synthetic training data that includes both a text string with example attributes and a label sequence for providing locality information of each attribute within the textual string, in order to enable rapid, accurate, and reliable training of a model, in accordance with an embodiment.

As illustrated in FIG. 3, the system 300 may include a synthetic data generating device 302 within which a synthetic data generating module 306 is embedded, a server 304, an attribute database 312, a textual template repository 314, a plurality of client devices 308(1) . . . 308(n), and a communication network 310.

In some embodiments, the synthetic data generating device 302 including the synthetic data generating module 306 may be connected to the server 304 the attribute database 312 and the textual template repository 314 via the communication network 310. The synthetic data generating device 302 may also be connected to the plurality of client devices 308(1) . . . 308(n) via the communication network 310, but the disclosure is not limited thereto. The attribute database 312 and the textual template repository 314 may include one or more repositories or databases.

In an embodiment, the synthetic data generating device 302 is described and shown in FIG. 3 as including the synthetic data generating module 306, although it may include other rules, policies, modules, databases, or applications, for example. In some embodiments, the attribute database 312 and the textual template repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the attribute database 312 and the textual template repository 314 may be a mainframe database, a log database that may produce programming for searching, monitoring, and analyzing machine-generated data via a web interface, but the disclosure is not limited thereto. In addition, the attribute database 312 and the textual template repository 314 may store a plurality of data sets and predictive models for generating synthetic training data.

In some embodiments, the synthetic data generating module 306 may be configured to receive a real-time feed of data from the plurality of client devices 308(1) . . . 308(n) and secondary sources via the communication network 310.

The synthetic data generating module 306 may be configured to: access a first dataset that includes a plurality of attributes associated with a domain of the domain-specific model; access at least one textual template in a predetermined format, wherein each of the at least one textual template includes at least one variable; select a first textual template from among the at least one textual template; generate a synthetic dataset by substituting each respective at least one variable of the first textual template with a respective attribute from the first dataset such that each respective attribute is arranged in a sequence defined by the first textual template, wherein the synthetic data set includes at least one pairing of a respective text string with a respective label sequence, wherein each respective text string is separated into a plurality of respective substrings, and wherein each respective label sequence includes a respective label that corresponds with each respective substring of the plurality of substrings; and train the domain-specific model using the synthetic dataset, wherein each respective text string provides a natural language simulated example, and each respective corresponding label sequence provides contextual information to facilitate learning by the domain-specific model.

The plurality of client devices 308(1) . . . 308(n) are illustrated as being in communication with the synthetic data generating device 302. In this regard, the plurality of client devices 308(1) . . . 308(n) may be “clients” (e.g., customers) of the synthetic data generating device 302 and are described herein as such. Nevertheless, it is to be known and understood that the plurality of client devices 308(1) . . . 308(n) need not necessarily be “clients” of the synthetic data generating device 302, or any entity described in association therewith herein. Any additional or alternative relationship may exist between either or both plurality of client devices 308(1) . . . 308(n) and the synthetic data generating device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the synthetic data generating device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The synthetic data generating device 302 may be the same or similar to the synthetic data generating device 202 as described with respect to FIG. 2, including any features or combination of features described with respect thereto.

Upon being started, the synthetic data generating device 302 executes a process for generating two-dimensional synthetic training data that includes both a text string with example attributes and a label sequence for providing locality information of each attribute within the textual string, in order to enable rapid, accurate, and reliable training of a model.

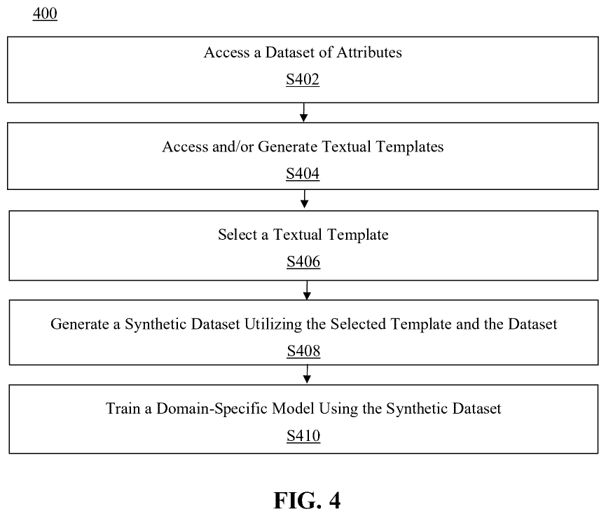

FIG. 4 illustrates a process 400 for generating two-dimensional synthetic training data that includes both a text string with example attributes and a label sequence for providing locality information of each attribute within the textual string, in order to enable rapid, accurate, and reliable training of a model. The two-dimensional synthetic training data includes (x, y) pairs of data, such that it includes both textual strings (i.e., x) and corresponding label sequences (i.e., y).

In process 400 of FIG. 4, at step S402, the synthetic data generating device 302 may access a first dataset that includes a plurality of attributes associated with a domain of a domain-specific model. The domain-specific model may be any LLM, artificial intelligence (AI), or learning based model that is designed for a specific field, category, task, domain, or genre, and requires knowledge or training of specific terminology and/or a specific structure. Each attribute may include a type of term, value, or text string that relates to the domain-specific model. In an embodiment, the domain-specific model may include a financial transaction labeling model, and the plurality of attributes may include a plurality of financial terms or example text associated with financial transactions. For example, the plurality of attributes may include examples of different types of at least one from among a ticker, a coupon, a maturity, an ISIN, an issuer, a CUSIP number, a price, a volume, a yield, a currency, a person, an organization series, and a spread. The dataset may be accessed from at least one from among a database, a generation function, and an LLM. The dataset may be determined based on the business need or domain-specific model and may include access to a plurality of values of entities or attributes of interest. The dataset may be accessed from an established database that includes the appropriate entity or attribute values of interest.

In an embodiment, the dataset may be generated by a generation function. The generation function may be a software-based code that has the ability to generate a series of example attribute values that conform to specific rules or considerations. For example, according to an embodiment, the generation function may be used to generate a dataset related to financial language, as illustrated in Table 1 below. This function may have the ability to generate random synthetic prices within a defined range, and ensure the output entities conform to directional considerations (e.g., /99 may imply a specific direction depending on the party writing the message).

TABLE 1
Representative Generation Functions.

| Entity | Function | Example Generations |
|---|---|---|
| country | create_synthetic_country( ) | New Zealand, Venezuela, |
| | | Kenya |
| coupon | create_synthetic_coupon(cou | 1.856, |
| | pon_type=[‘decimal’, | 0.208%, |
| | ‘fraction’, ‘float’, ‘random’], | Float, |
| | floating_coupon_prob=0.25) | 2 ¼, |
| | | 6 ⅛% |
| currency | create_synthetic_currency(lo | BDT, ugx, $$$, ¥ |
| | wer_prob=0.3) | |
| cusip | create_synthetic_cusip( ) | 539830BU2, 517834AG2, |
| | | 362338AQ8 |
| datetime | def | jun 23, |
| | create_synthetic_date(th_endi | Oct. 4, 20, |
| | ng_prob=0.5) | 9/15^{th} |
| | | jul 18^{th} |
| direction | def | I am a buyer of, |
| | create_synthetic_trade_directi | Bid, |
| | on( | Offer, |
| | is_internal=False, | I lifted, |
| | entities=None, shared=False | You hit, |
| | ) | Need to lift, |
| isin | create_synthetic_isin( ) | USG47567AD78, |
| | | DE000LB19R46, |
| | | TW0006414303 |
| maturity_expiry | def | July ~2086s |
| | create_synthetic_maturity( | 2016 Mar. 7 |
| | high_year=“2100”, | 2013E |
| | low_year=“1990”, | 08/19/01's |
| | expiry_like=True, | |
| | p_add=True | |
| | ): | |
| organization | create_synthetic_client_org( ) | SCOUT |
| | | LYXOR ASSET, |
| | | BTG, |
| | | KBC |
| person | create_synthetic_name( | jane roe, john a. doe, john |
| | prob_last=0.8, | smith, john q. public, |
| | prob_initial=0.3, | richard bloggs |
| | lower_prob=0.6, | |
| | first_upper_prob=0.6, | |
| | all_upper=False ) ) | |
| price | def create_synthetic_price( | @356 |
| | price_type=None, | @205/ |
| | bid_high=400, | 179 |
| | bid_low=10, | ¥174.94 - |
| | ask_delta_high=50, | @£165.53/ |
| | ask_delta_low=1, | |
| | direction=None, | |
| | ) | |
| rating | create_synthetic_rating(lower | Ca3 |
| | _prob=0.5) | CCC |
| | | BB |
| | | AA |
| | | C1 |
| Near_term/far_term | def | Spot/next, |
| | add_synthetic_repo_entities( | s/n |
| | string, repo_entities, | 1 w 2 wks, |
| | entities, add_shared=False | 1 w 4 m, |
| | ) | |
| series | create_synthetic_series( ) | REGS, |
| | | reg's, |
| | | 144a's, |
| spread | create_synthetic_spread( | 102 bp/120 bp |
| | spread_type=“/”, | 554 bps/601 bps |
| | bid_high=900, | 893-914 |
| | bid_low=10, | 678/719 |
| | ask_delta_high=50, | |
| | ask_delta_low=1, | |
| | ) | |
| ticker | create_synthetic_ticker(inclu | REITPA |
| | de_countries=True) | SATELD |
| | | GMREIN |
| | | CISSTB |
| | | BLURET |
| tranche | create_synthetic_tranche( ) | ‘2081-HI4’ |
| | | ‘1971-RZ8’ |
| | | ‘2086-NC3’ |
| | | ‘1978-RZ2’ |
| volume_notional | create_synthetic_volume_noti | 44 m |
| | onal(volume_type=[“mm_k”, | 332.0.45 mil |
| | “int_comma”, “int”, “mixed” | 200 MM, |
| | ]) | 44928480000000 |
| strike_price | create_synthetic_strike_price( | 2700, |
| | ) | 5000, |
| | | 234, |
| | | 277/200 |
| put | create_synthetic_put( ) | Put, |
| | | P |
| call | create_synthetic_call( ) | Call, |
| | | calls, |
| | | C |

The generation functions may have the capability to generate random text values based on their implementation, including specific dynamic probability assignments to key features of each entity type to create variation. While the values shown in Table 1 represent the various entities independently for brevity, the synthetic data generating device 302 may provide coherence between entity types. For example, in an externally produced text, price values of “/99” imply a client's intent to “offer” a price for the specified financial product. In these cases, the synthetic data generating device 302 may only produce language content for the entity “direction” indicating a SELL direction from the perspective of the client.

At step S404, the synthetic data generating device 302 may access at least one textual template that is arranged in a predetermined format. The textual templates may be accessed from a database of stored textual templates. In an embodiment, the synthetic data generating device 302 may generate the textual templates using a model (e.g., LLM). Each textual template may include at least one variable that corresponds to a specific entity or attribute type/category. In an embodiment, each textual template may include a sequence of attributes that are associated with the domain-specific model. The sequence may be in a particular predetermined order that is specific to the domain-specific model. In some embodiments, each respective variable may be an attribute label for identifying the category or type of corresponding attribute from the sequence of attributes. In an embodiment, the domain-specific model may include a financial transaction labeling model, and each textual template may be an external format/grammar set which defines what and how to concatenate different entities into a trading text. For example, the format may include something like “{Buy}{Ticker}{Coupon}{Maturity}”, where “Buy”, “Ticker”, “Coupon”, “Maturity” are entity types that play an important role in financial trading. In this example set, it could be hundreds or thousands of predefined grammars according to user's intent. Thus, the framework of the synthetic data generating device 302 may be flexible to adapt to a variety of business and model types. Example grammar formats for this financial transaction labeling model, are illustrated in Table 2 below.

TABLE 2
Typical request for quote examples in a financial transaction labeling
model and the corresponding format (space characters are omitted,
each label is paired with one word or a punctuation character).

| Product | Label Type | Plain Text | Grammar |
|---|---|---|---|
| Credit | Name | BID | [buy][O] |
| Repurchase | entity | BTPS 2.45 09/50 IT0005398406 | [ticker][coupon][maturity][isin][vol |
| | recognition | 1.5000 | ume] [O] |
| | | BTPS 2.8 03/67 IT0005217390 | [ticker][coupon][maturity][isin][vol |
| | | 33.0000 | ume] [O] |
| | | NETHER 0 01/29 NL0015000LS8 | [ticker][coupon][maturity][isin][ vo |
| | | 103.0000 | lume] [O] |
| | | RAGB 0.25 10/36 AT0000A2T198 | [ticker][coupon][maturity][isin][vol |
| | | 47.0000 | ume] [O] |
| | | OFFER | [sell] [O] |
| | | BTPS 2.95 09/38 IT0005321325 | [ticker][coupon][maturity][isin][vol |
| | | −63.0800 | ume] [O] |
| | | BTPS 5 09/40 IT0004532559 | [ticker][coupon][maturity][isin][vol |
| | | FRTR 1.25 05/36 FR0013154044 | ume] [O] |
| | | −44.6600 | [ticker][coupon][maturity][isin][vol |
| | | NETHER 0 01/38 NL0015000B11 | ume] [O] |
| | | −46.5000 s/n | [ticker][coupon][maturity][isin][vol |
| | | | ume] [O] |
| | | | [near_term][O][far_term] |
| Credit | Name | Spot/next | [near_term][O][far_term] |
| Repurchase | entity | bid 12.2bln HU0000403068 | [buy][volume][isin][ticker][coupon |
| | recognition | offer 4.23bln HU0000403571 | ][maturity] [O] |
| | | offer 17.27bln HU0000404934 | [sell][volume][isin][ticker][coupon |
| | | | ][maturity] [O] |
| | | | [sell][volume][isin][ticker][coupon |
| | | | ][maturity] [O] |
| Credit | Name | MOUNIR GOURRAM BNPPAM | [person][organization][sell][volum |
| Cash | entity | buyer 2mios DOMREP 5.3 | e][ticker][coupon][maturity][series] |
| | recognition | 01/21/2041 REGS | [O] |
| | | BNPPAM seller 1mio DOMREP | [organization][buy][volume][ticke |
| | | 6.85 01/27/2045 REGS | r][coupon][maturity][series][O] |
| Credit | Name | william munch buys 4mio XS2 | [person][sell][volume][isin] |
| Cash | entity | 214239175 | |
| | recognition | | |
| Credit | Relation | GEERT DHONT | [O][O][O] |
| Cash | recognition | 10:17:36 do you prefer for | [O][O][O][O][O][Leg1, Leg2] |
| | | $2.7mio BRASKM 23's or | [Leg1] [Leg1] [O] |
| | | Tesla 24's? | [Leg2] [Leg2] |
| Equity | Name | CS FP jun23 25 puts, 27.09 ref, | [asset][expiry][strike][put][O][ref][ |
| Derivatives | entity | 2k | O][O][units] |
| | recognition | | |
| Equity | Name | SX7E jun23 82.5/97.5 | [asset][expiry][strike][strike][callsp |
| Derivatives | entity | CallSpread in 6000 lots vs 89.9 | read][O][units][O][O][ref][asset] |
| | recognition | CAZ2 | |
| Equity | Name | zurn sw stgdiag 390/410 mar22 | [asset][strangle][strike][O][strike][ |
| Derivatives | entity | vs 400/430 jun22 1.5k vs 440.5 | expiry][vs][strike][strike] |
| | recognition | eurex | [expiry][units][ref][exchange] |
| Equity | Name | Pls quote SPX: 75 Dec20 3500 | [O][direction][asset][O][units][expi |
| Derivatives | entity | straddle tied to 3571 ESZO | ry][strike][straddle][O][O][ref][ass |
| | recognition | | et] |
| Equity | Name | CBK GY dec22 8 calls, 7.02 | [asset][expiry][strike][call][O][ref] |
| Derivatives | entity | ref, 4k, thx | [O] [units][O][O] |
| | recognition | | |

At step S406, the synthetic data generating device 302 may select a textual template from the at least one textual template. In some embodiments, the textual template may be selected by a user. In an embodiment, the synthetic data generating device 302 may select the textual template based on the required task of the domain-specific model. The textual template may be selected based on a probability distribution. For example, according to an embodiment, the domain-specific model may be a financial transaction labeling model and the synthetic data generating device 302 may be used for financial trading. In this scenario, the synthetic data generating device 302 may select the template: “{Buy}{Ticker}{Coupon}{Maturity}”, that indicates the categories of attributes, as well as the proper sequence, which may be received by the domain-specific model to perform financial trading.

At step S408, the synthetic data generating device 302 may generate a synthetic dataset utilizing the selected template and the dataset. In an embodiment, the synthetic dataset may be generated by substituting each respective variable of the selected textual template with respective corresponding attribute values from the dataset, such that each respective attribute value is arranged in a sequence or order as defined by the template. The synthetic dataset may include at least one text string of attribute values and at least one respective corresponding label sequence. The synthetic dataset may be arranged such that each respective text string is paired with a corresponding respective label sequence that defines the order of attributes of the respective text string. Additionally, each text string may be separated into a plurality of substrings and each substring may be an individual attribute value. Moreover, each respective label sequence may include a respective label that corresponds with each respective substring of the plurality of substrings.

In an embodiment, each respective label sequence may identify an attribute type for each respective substring/attribute within the synthetic dataset. For example, according to an embodiment, the dataset may have the following text string “William/john bid/ask/buy 20 k/4mio XS1287809047/USG47567AD78” that is paired with the corresponding label sequence “[person][sell][volume][isin]. In some embodiments, each respective label sequence may include a corresponding starting position index and a corresponding ending position index for each respective corresponding text string, such that the order of the substrings/attributes within the text string is defined. For example, according to an embodiment, the domain-specific model may include an NER model for tagging entities. During the tagging process, the entities may be tagged with their label and (start, end) index. Moreover, the domain-specific model may include a relation classification model, and entities may be tagged with the relation they belong to. In some embodiments, the synthetic data generating device 302 may rapidly generate synthetic data for training sequence labeling tasks. The generated synthetic data may include clean (text, label)/(x, y) pairs, where x is the input string which is sliced into n tokens/substrings, and y is a sequence of corresponding labels. In the below formula, x represents the sequence of tokens and y represents the entity space or relation space associated with each token. Together these may comprise the training material for a sequence labeling model.

x={t₁, t₂, tᵢ . . . tₙ}, y={e¹, e², e^{j} . . . eⁿ} Where
eⁱ∈E, i, j∈[1, n] and E is the entity space or the relation space.

The synthetic data may then be used to train models used in deployment of financial sequence labeling tasks. The addition of synthetic data may create robust model performance. Rather than rely upon manually sampled and collected information to influence model behavior, the domain-specific model may be driven by increasing/decreasing populations of specific examples known to produce a desired behavior.

In an embodiment, the synthetic dataset may include simulated noise in order to mimic potential errors and typographical errors that may occur with real life data. For example, according to an embodiment, to mimic daily conversations, for which the domain-specific model may be used to analyze, where typos and synthetic error will randomly happen, the synthetic data generating device 302 may add noise (e.g., random capitalization, random string punctuation, various greeting words, etc.) to the generated text. In some embodiments, the synthetic dataset may be formatted as a table. For example, according to an embodiment, where the domain-specific model is a financial transaction labeling model, the table may include synthetic multi-leg trading data for at least one from among a buying of a respective financial product and a selling of a respective financial product.

At step S410, the synthetic data generating device 302 may train the domain-specific model using the synthetic dataset. Each respective text string of the synthetic dataset may provide a natural language simulated example that emulates the type of data, text, and/or input that will be received by the domain-specific model in actual practice. Additionally, each respective corresponding label sequence may provide contextual information to facilitate learning by the domain-specific model. The contextual information may relate to the identity and/or order of the text string. For example, the corresponding label sequence may provide the attribute type of each respective attribute value in the text string, as well as the order or sequence of the attributes in the text string.

In an embodiment, the synthetic data generating device 302 may generate synthetic texts which mimic the desired distribution of a selected format (e.g., financial language), while simultaneously providing accurate labels for target y-objectives. The methodology may include a logical sequence of steps forming a pipeline, which may be implemented within a diverse set of environments or contexts. The resulting data may be most beneficial to model training in the cold-start phase and subsequent retraining stages where specific model behavior is desired. Furthermore, the resulting synthetic data may be used as a reliable robustness tester in the post-training stage.

In some embodiments, the synthetic data generating device 302 may be used in a variety of fields (e.g., artificial intelligence, machine learning, natural language processing, natural language generation, named entity recognition, named entity disambiguation, event extraction, relation classification, and model evaluation). The methodology can be customized by user-defined grammar or prompts to include any scenario, demonstrating its adaptability and versatility. Thus, the synthetic data generating device 302 may allow for the rapid iteration of machine learning models focused on specific performance objectives.

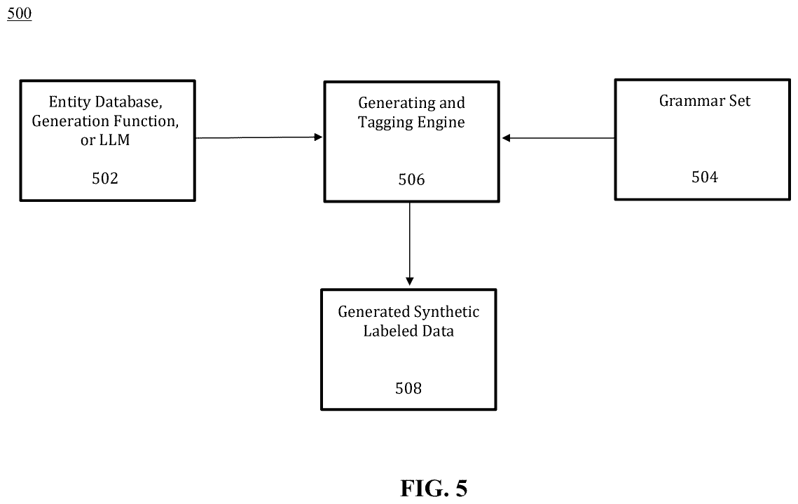

FIG. 5 illustrates an architectural diagram of a process 500 for generating two-dimensional synthetic training data that includes both a text string with example attributes and a label sequence for providing locality information of each attribute within the textual string, in order to enable rapid, accurate, and reliable training of a model, according to an embodiment. As illustrated in FIG. 5, an entity database, generation function, or LLM module 502 provides example entities or attributes to the generating and tagging engine 506. Additionally, the grammar set module 504 provides example grammar, syntax, template, and/or label sequence sets to the generating and tagging engine 506. In an embodiment, the grammar set module 504 may generate the example grammar, syntax, template, and/or label sequence sets using a model (e.g., LLM). The generating and tagging engine 506 then uses both of the supplied example data to generate synthetic labeled data 508. The external entity database, generation function, or LLM module 502 may be the same or similar to the attribute database 312. Additionally, the grammar set module 504 may be the same or similar to the textual template repository 314.

Particularly, the external entity database, generation function, or LLM module 502 may be determined by business need and may include access to values of entities of interest. For example, according to an embodiment, a typical corporate bond pricing request text may include many of the following: ticker, coupon, maturity, isin, issuer, cusip, price, volume, yield, currency, person, organization series, and spread. While in the repurchase market, entity types such as near_term, far_term, and haircut may be common, in addition to other bond parameter identifiers: ticker, coupon, maturity, etc. For example, a ticker may be interpreted as a government or corporate issuer of a fixed-income (bond) financial product; isin is the unique identifier for each bond product and is a character string with a fixed length of twelve (e.g., “XS1287809047”, “DE000DC85WN3”, “USG47567AD78”, “DE000LB19R46”).

In some embodiments, the external entity database, generation function, or LLM module 502 may be a generation function for an entity type price. This function may have the ability to generate random synthetic prices within a defined range and ensure the output entities conform to directional considerations (e.g., /99 implies a specific direction depending on the party writing the message). Additionally, the external entity database, generation function, or LLM module 502 may have the capability to generate random text values based on their implementation, including specific dynamic probability assignments to key features of each entity type to create variation. For example, in an externally produced text, price values of “/99” imply a client's intent to “offer” a price for the specified financial product. In these cases, the external entity database, generation function, or LLM module 502 may only produce language content for the entity “direction” indicating a SELL direction from the perspective of the client.

Additionally, the grammar set module 504 may define what and how to concatenate different entities into a trading text. Formats may be something like “{Buy}{Ticker}{Coupon}{Maturity}”, where “Buy”, “Ticker”, “Coupon”, “Maturity” are entity types that play an important role in financial trading. In this set, it could be hundreds or thousands of predefined grammars according to user's intent.

The generating and tagging engine 506 may generate complete (X,Y) pairs programmatically which may be used to train supervised systems. This means the label not only includes the entity type but also has the corresponding start and end position/index. The index may be key for model training. The generating and tagging engine 506 may be an internally implemented model/algorithmic system or may be externally supplied through an LLM. The generating and tagging engine 506 may have the ability to provide coherence across the entities present in the message. For example, buy/sell directions must be accompanied by specific string patterns of prices, and strangle options must contain two strike prices. Given the entity dataset and format/grammar/template set, the generating and tagging engine 506 may pick one grammar according to a probability distribution and substitute the entity holders with entity spans selected from the entity dataset. To mimic the daily conversations where typos and synthetic error will randomly happen, the generating and tagging engine 506 may add “noise” (random capitalization, random string punctuation, various greeting words, etc.) to the generated text. The generating and tagging engine 506 may also support table data generation which is popular in multi-leg trading where client will buy/sell different financial products.

For example, according to an embodiment, the external entity database, generation function, or LLM module 502 may include the following entity examples: [person]: {william, john}; [sell]: {bid, ask, buy}; [volume]: {20 k, 4mio}; [isin]: {“XS1287809047”, “USG47567AD78”}. Additionally, the grammar set module 504 may include the corresponding grammar examples: [person][sell][volume][isin]. These examples may then be fed into the generating and tagging engine 506, which may output the following generated and synthetic labeled data 508 for NER: X=>William/john bid/ask/buy 20 k/4mio XS1287809046/USG47567AD78; Y=> [person][sell] [volume][isin].

In an embodiment, the entity database, generation function, or LLM module 502 may be an LLM that is prompted to provide example entities and grammar. For example, the LLM prompt template may be: “You are a trade platform with financial bonds, you can switch the role between the salespeople and the clients, your task is to replace the # entity type # within the brackets in below grammar with real entity spans and generate natural texts that could happen in a real bond trade conversation. \n **Keep the brackets and Don't return any explanation nor note. **\n. Possible entities include {entity type list}, etc. For some entities you are given the candidate entity span which you **must choose one of them**, for other entities without candidates you should replace it on your own. Your return should be creative and natural. **Try not use explicit entity words like “ticker”, “coupon”, “maturity” or similar in the text**. \n You are given entity candidates: {candidates for each entity type} \n Grammar: {grammar} \n generate {N} trade text of the same grammar; be creative to make those trade texts are different in syntax, semantic and text length.”

The entity database, generation function, or LLM module 502 may then use this prompt to replace the parts in { } with real candidates from datasets. For example, the prompt with the replaced parts may then become: “You are a trade platform with financial bonds, you can switch the role between the salespeople and the clients, your task is to replace the # entity type # within the brackets in below grammar with real entity spans and generate natural texts that could happen in a real bond trade conversation. \n **Keep the brackets and Don't return any explanation nor note.**\n. Possible entities include “TICKER”, “COUPON”, “MATURITY”, etc. For some entities you are given the candidate entity span which you **must choose one of them**, for other entities without candidates you should replace it on your own. Your return should be creative and natural. **Try not use explicit entity words like “ticker”, “coupon”, “maturity” or similar in the text**. \n You are given entity candidates: TICKER: “testla”, “Apple”, “amazon”, “google”, “sp500” \n COUPON: 2⅔, 0.2, 0.1 \n MATURITY: “prep”, “Dec. 12, 2024”, “Juan23”. \n BUY: “offer”, “buyer”, “buy”, “lift”, “quote”, “purchase”, “ask”, “borrow”, “OWIC”.\n grammar: [free-text][BUY][ticker][coupon][maturity][free-text] \n generate 10 trade text of the same grammar; be creative to make those trade text are different in syntax, semantic and text length.”

Using this example, the entity database, generation function, or LLM module 502 may then provide the following outputs: 1. “We have a client looking to [buy] the bond from [Apple] with a [2⅔] return, maturing on [Dec. 12, 2024].” 2. “There's an [offer] on the table for the bond issued by [google] with a [0.1] yield, due on [Dec. 12, 2024].” 3. “A client is interested to [purchase] the bond from [tesla], offering a [0.2] return and maturing on [Dec. 12, 2024].” 4. “We have a [quote] for the bond tied to the [sp500] index with a [2⅔] yield, due on [Dec. 12, 2024].” 5. “A client is looking to [borrow] the bond issued by [amazon] offering a [0.1] return, maturing on [Dec. 12, 2024].” 6. “We have an [OWIC] for the bond from [Apple] with a [0.2] yield, due on [Dec. 12, 2024].” 7. “There's a client looking to [lift] the bond issued by [google] with a [2⅔] return, due on [Dec. 12, 2024].” 8. “We have a [buyer] for the bond from [tesla], offering a [0.1] yield and maturing on [Dec. 12, 2024].” 9. “There's an [ask] for the bond tied to the [sp500] index with a [0.2] return, due on [Dec. 12, 2024].” And 10. “A client is interested to [quote] the bond issued by [amazon] offering a [2⅔] yield, maturing on [Dec. 12, 2024].”

Accordingly, with this technology, an optimized process for generating two-dimensional synthetic training data that includes both a text string with example attributes and a label sequence for providing locality information of each attribute within the textual string, in order to enable rapid, accurate, and reliable training of a model is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating synthetic data for training a domain-specific model, the method being implemented by at least one processor, the method comprising:
accessing, by the at least one processor, a first dataset that includes a plurality of attributes associated with a domain of the domain-specific model;
accessing, by the at least one processor, at least one textual template in a predetermined format, wherein each of the at least one textual template includes at least one variable;
selecting, by the at least one processor, a first textual template from among the at least one textual template;
generating, by the at least one processor, a synthetic dataset by substituting each respective at least one variable of the first textual template with a respective attribute from the first dataset such that each respective attribute is arranged in a sequence defined by the first textual template,
wherein the synthetic data set includes at least one pairing of a respective text string with a respective label sequence,
wherein each respective text string is separated into a plurality of respective substrings, and
wherein each respective label sequence includes a respective label that corresponds with each respective substring of the plurality of respective substrings; and
training, by the at least one processor, the domain-specific model using the synthetic dataset,
wherein each respective text string provides a natural language simulated example, and each respective corresponding label sequence provides contextual information to facilitate learning by the domain-specific model.

2. The method of claim 1, wherein the first dataset is accessed via at least one from among a database, a generation function, and a large language model (LLM).

3. The method of claim 1, wherein each respective textual template of the at least one textual template includes a respective sequence of attributes associated with the domain-specific model, and
wherein each respective variable of the at least one variable is an attribute label associated with a corresponding attribute from the respective sequence of attributes.

4. The method of claim 1, wherein each respective label sequence includes a corresponding starting position index and a corresponding ending position index for each respective category of interest in each corresponding text string.

5. The method of claim 1, wherein each respective label sequence may identify and correspond to a complete set of attributes within a synthetic example.

6. The method of claim 1, wherein the synthetic dataset includes a simulated noise, wherein the simulated noise includes at least one from among language variation in words, a random capitalization, a random punctuation, and a random greeting word within at least one respective substring.

7. The method of claim 1, wherein the domain-specific model includes a financial transaction labeling model.

8. The method of claim 7, wherein the plurality of attributes is associated with a financial language, and wherein the plurality of attributes includes at least one from among a ticker, a coupon, a maturity, an International Securities Identification Number (ISIN), an issuer, a Committee on Uniform Securities Identification Procedures (CUSIP) number, a price, a volume, an expiry date, a barrier option, a product identifier, a yield, a currency, a person, an organization series, and a spread.

9. The method of claim 7, wherein the synthetic dataset is formatted as a table that includes synthetic multi-leg trading data for at least one from among a buying of a respective financial product and a selling of a respective financial product.

10. A computing apparatus for generating synthetic data for training a domain-specific model, the computing apparatus comprising:
a processor;
a memory; and
a communication interface coupled to each of the processor and the memory,
wherein the processor is configured to:
access a first dataset that includes a plurality of attributes associated with a domain of the domain-specific model;
access at least one textual template in a predetermined format, wherein each of the at least one textual template includes at least one variable;
select a first textual template from among the at least one textual template;
generate a synthetic dataset by substituting each respective at least one variable of the first textual template with a respective attribute from the first dataset such that each respective attribute is arranged in a sequence defined by the first textual template,
wherein the synthetic data set includes at least one pairing of a respective text string with a respective label sequence,
wherein each respective text string is separated into a plurality of respective substrings, and
wherein each respective label sequence includes a respective label that corresponds with each respective substring of the plurality of respective substrings; and
train the domain-specific model using the synthetic dataset,
wherein each respective text string provides a natural language simulated example, and each respective corresponding label sequence provides contextual information to facilitate learning by the domain-specific model.

11. The computing apparatus of claim 10, wherein the first dataset is accessed via at least one from among a database, a generation function, and a large language model (LLM).

12. The computing apparatus of claim 10, wherein each respective textual template of the at least one textual template includes a respective sequence of attributes associated with the domain-specific model, and
wherein each respective variable of the at least one variable is an attribute label associated with a corresponding attribute from the respective sequence of attributes.

13. The computing apparatus of claim 10, wherein each respective label sequence includes a corresponding starting position index and a corresponding ending position index for each respective category of interest in each corresponding text string.

14. The computing apparatus of claim 10, wherein each respective label sequence may identify and correspond to a complete set of attributes within a synthetic example.

15. The computing apparatus of claim 10, wherein the synthetic dataset includes a simulated noise, wherein the simulated noise includes at least one from among language variation in words, a random capitalization, a random punctuation, and a random greeting word within at least one respective substring.

16. The computing apparatus of claim 10, wherein the domain-specific model includes a financial transaction labeling model.

17. The computing apparatus of claim 10, wherein the plurality of attributes is associated with a financial language, and wherein the plurality of attributes includes at least one from among a ticker, a coupon, a maturity, an International Securities Identification Number (ISIN), an issuer, a Committee on Uniform Securities Identification Procedures (CUSIP) number, a price, a volume, an expiry date, a barrier option, a product identifier, a yield, a currency, a person, an organization series, and a spread.

18. The computing apparatus of claim 10, wherein the synthetic dataset is formatted as a table that includes synthetic multi-leg trading data for at least one from among a buying of a respective financial product and a selling of a respective financial product.

19. A non-transitory computer readable storage medium storing instructions for generating synthetic data for training a domain-specific model, the storage medium comprising executable code which, when executed by a processor, causes the processor to:
access a first dataset that includes a plurality of attributes associated with a domain of the domain-specific model;
access at least one textual template in a predetermined format, wherein each of the at least one textual template includes at least one variable;
select a first textual template from among the at least one textual template;
generate a synthetic dataset by substituting each respective at least one variable of the first textual template with a respective attribute from the first dataset such that each respective attribute is arranged in a sequence defined by the first textual template,
wherein the synthetic data set includes at least one pairing of a respective text string with a respective label sequence,
wherein each respective text string is separated into a plurality of respective substrings, and
wherein each respective label sequence includes a respective label that corresponds with each respective substring of the plurality of respective substrings; and
train the domain-specific model using the synthetic dataset,
wherein each respective text string provides a natural language simulated example, and each respective corresponding label sequence provides contextual information to facilitate learning by the domain-specific model.

20. The storage medium of claim 19, wherein the first dataset is accessed via at least one from among a database, a generation function, and a large language model (LLM).
